(19) United States
(12) Patent Application Publication
(10) Pub. No.: US 2006/0153294 A1
(43) Pub. Date: Jul. 13, 2006

(54) Inter-layer coefficient coding for scalable video coding

(75) Inventors: Xianglin Wang, Irving, TX (US); Yiliang Bao, Coppell, TX (US); Marta Karczewicz, Irving, TX (US); Justin Ridge, Sachse, TX (US)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/330,704

(22) Filed: Jan. 11, 2006

Related U.S. Application Data
(60) Provisional application No. 60/643,444, filed on Jan. 12, 2005.

(51) Int. Cl. H04N 7/12; H04N 11/04; H04B 1/66; H04N 11/02

(52) U.S. Cl. 375/240.08; 375/240.24; 375/240.23

(57) ABSTRACT

A scalable video coding method and apparatus for coding a video sequence, wherein the coefficients in the enhancement layer is classified as belonging to a significant pass when the corresponding coefficient in the base layer is zero, and classified as belonging to a refinement pass when the corresponding coefficient in the base layer is non-zero. For coefficients classified as belonging to the significance pass, an indication is coded to indicate whether the coefficient is zero or non-zero, and if the coefficient is non-zero, coding an indication of the sign of the coefficient. A last_significant_coeff_flag is used to indicate the coding of remaining coefficients in the scanning order can be skipped. For coefficients classified as belonging to the refinement pass, a value to refine the magnitude of the corresponding coefficient in the base layer is coded, and if the coefficient is non-zero, a sign bit may be coded.

### CROSS REFERENCE TO RELATED APPLICATIONS

This patent application is based on and claims priority to U.S. provisional patent application No. 60/643,444, filed Jan. 12, 2005.

The present invention is related to co-pending U.S. patent application Ser. Nos. 10/797,467, 10/797,635, filed Mar. 9, 2004, and 10/891,271, filed Jul. 9, 2004. All these applications are assigned to the assignee of the present invention.

### FIELD OF THE INVENTION

The present invention relates to the field of video coding, and, more specifically, to scalable video coding.

### BACKGROUND OF THE INVENTION

Conventional video coding standards (e.g. MPEG-1, H.261/263/264) involve encoding a video sequence according to a particular bit rate target. Once encoded, the standards do not provide a mechanism for transmitting or decoding the video sequence at a different bit rate setting to the one used for encoding. In contrast, with scalable video coding, the video sequence is encoded in a manner such that an encoded sequence characterized by a lower bit rate can be produced simply through manipulation of the bit stream; in particular through selective removal of bits from the bit stream.

The Scalable Video Model (SVM) proposed in Scalable Video Model 3.0 (ISO/IEC JTC 1/SC 29/WG 11N6716, October 2004, Palma de Mallorca, Spain) is based on H.264 (ITU-T Recommendation, H.264, “Advanced video coding for generic audiovisual services”, May 30, 2003). In an SVM codec, a video sequence can be coded in multiple layers, and each layer is one representation of the video sequence at a certain spatial resolution or temporal resolution or at a certain quality level or some combination of the three.

In a typical single layer video scheme, such as H.264, a video frame is processed in macroblocks. If the macroblock (MB) is an inter-MB, the pixels in one macroblock can be predicted from the pixels in one or multiple reference frames. If the macroblock is an intra-MB, the pixels in the MB in the current frame can be predicted entirely from the pixels in the same video frame.

For both inter-MB and intra-MB, the MB is decoded in the following steps:
Decode the syntax elements of the MB, syntax elements include the prediction modes and associated parameters;
Based on syntax elements, retrieve the pixel predictors for each partition of MB. An MB can have multiple partitions, and each partition can have its own mode information;
Perform entropy decoding to obtain the quantized coefficients;
Perform inverse transform on the quantized coefficients to reconstruct the prediction residue; and
Add pixel predictors to the reconstructed prediction residues in order to get the reconstructed pixel values of the MB.

At the encoder side, the prediction residues are the difference between the original pixels and their predictors. The residues are transformed and the transform coefficients are quantized. The quantized coefficients are then encoded using a certain entropy-coding scheme.

In a scalable video codec built on top of a single layer codec, in addition to the existing modes already defined in the single layer codec, some new texture prediction modes and syntax prediction modes are used for reducing the redundancy among the layers in order to achieve good coding efficiency.

In the following description, the texture prediction modes are those modes for computing the best pixel predictors for the MB being coded, such as intra prediction mode, and inter prediction mode. The syntax prediction modes help reduce the bits spent on encoding the syntax elements, such as motion vectors. Some of these prediction modes are as follows:

Base Layer Texture Prediction (BLTP)

In this mode, the pixel predictors for the whole MB or part of the MB are from the co-located MB in the base layer. New syntax elements are needed to indicate such a prediction. This is similar to inter-frame prediction, but no motion vector is needed because the locations of the predictors are known. This mode is illustrated in FIG. 1. In FIG. 1, C1 is the original MB in the enhancement layer coding, and B1 is the reconstructed MB in the base layer for the current frame used in predicting C1. In FIG. 1, the enhancement layer frame size is the same as that in the base layer. If the base layer is of a different size, proper scaling operation on the base layer reconstructed frame is needed.

Residue Prediction (RP)

In this mode, the reconstructed prediction residue of the base layer is used in reducing the amount of residue to be coded in the enhancement layer, when both MBs are encoded in inter mode.

In FIG. 1, the reconstructed prediction residue in the base layer for the block is (B1−B0). The best reference block in the enhancement layer is E0. In Residue Prediction mode, adjusted predictor (E0+(B1−B0)) is used in predicting C1. If we calculate the prediction residue in this mode, we shall get
C1−(E0+(B1−B0))=(C1−E0)−(B1−B0).

If the residue prediction is not used, the normal prediction residue of (C1−E0) in the enhancement layer is encoded. What is encoded in RP mode is the difference between the first order prediction residue in the enhancement layer and the first order prediction residue in the base layer. Hence this texture prediction mode is referred to as Residue Prediction. A flag is needed to indicate whether such a mode is used in encoding the current MB.

In residue prediction mode, the motion vector mvₑ is not necessarily equal to motion vector mv_{b} in actual coding.

In SVM, both BLTP and RP are just different ways of computing the pixel predictors if we compare them with the existing texture prediction modes in single layer coding. Once the predictors, either normal predictors or residue-adjusted predictors, are computed using the new modes, the other steps of encoding (in the encoder) or reconstructing (in the decoder) do not change.

### SUMMARY OF THE INVENTION

The present invention presents methods for coding the enhancement layer quantized coefficients more efficiently. In particular, the present invention is more concerned with coding the quantized coefficients in the enhancement layer using context-based adaptive binary arithmetic coding. An even more specific scalable video codec is developed based on H.264 with CABAC, an H.264 specific context-based adaptive binary arithmetic coding engine.
The present invention uses the information in the base layer in coding the quantized coefficients in the enhancement layer;
The present invention classifies the coefficients according to whether a coefficient at the same location in the base layer has been quantized to zero or not.
   1. For the coefficients with their corresponding coefficients in the base layer being zero, they are coded in a significant coefficient coding pass. The significant coefficient coding pass is similar to the coefficient coding scheme in H.264. Same sets of contexts can be used, or the same mechanism, but different sets of contexts can be used depending on whether a block has some coefficients for which their corresponding coefficients in the base layer are nonzero; and
   2. For the coefficients with their corresponding coefficients in the base layer being nonzero, they are encoded in a refinement pass. Coefficients coded in this pass are further classified based on the prediction mode used for the current MB in the enhancement layer. Coefficients coded in this pass can also be classified based on difference between the motion vector of the block in the enhancement layer and the motion vector of the block in the base layer.
A flag can be used for switching the coefficient-coding scheme between the classification-based scheme and the normal H.264 scheme. In one embodiment of the present invention, it may not be necessary to send the flag explicitly if the other coding parameters favor a particular scheme. In one scenario, when the same original signals are encoded in both the base layer and the enhancement layer, the quantization parameters in the enhancement layer and base layer can be used for determining which entropy coding scheme should be chosen;
In another embodiment, the entropy coding scheme is used with residue prediction mode. The base layer prediction residue is subtracted from the enhancement layer prediction residue as described above;
In yet another embodiment, the prediction residue in the base layer is not subtracted from the enhancement layer prediction residue. The base layer prediction residue can be transformed and quantized. These quantized coefficients can be used in classifying the coefficients that are being coded in the enhancement layer; and
In a different embodiment, the prediction residues in the base layer can be modified before they are applied in residue prediction.

It should be noted that SVM uses the unmodified AVC coefficient entropy coder to code the quantized coefficients without using the information in base layer coefficients and inter-layer prediction modes. For that reason, the remaining correlation between coefficients in enhancement layer and those in base layer cannot be exploited.

With the present invention, new texture prediction modes introduced in the SVM could generate better pixel predictors for some macroblocks in the enhancement layer as compared to the modes defined in the single layer codec. Although the base layer texture has been subtracted from the original MB in the enhancement layer when either BLTP or RP mode is used, statistically there still exists a strong correlation between the coefficients in the enhancement layer and those in the base layer.

### BRIEF DESCRIPTION OF THE DRAWINGS

FIG. 1 shows the texture prediction modes in scalable video coding.

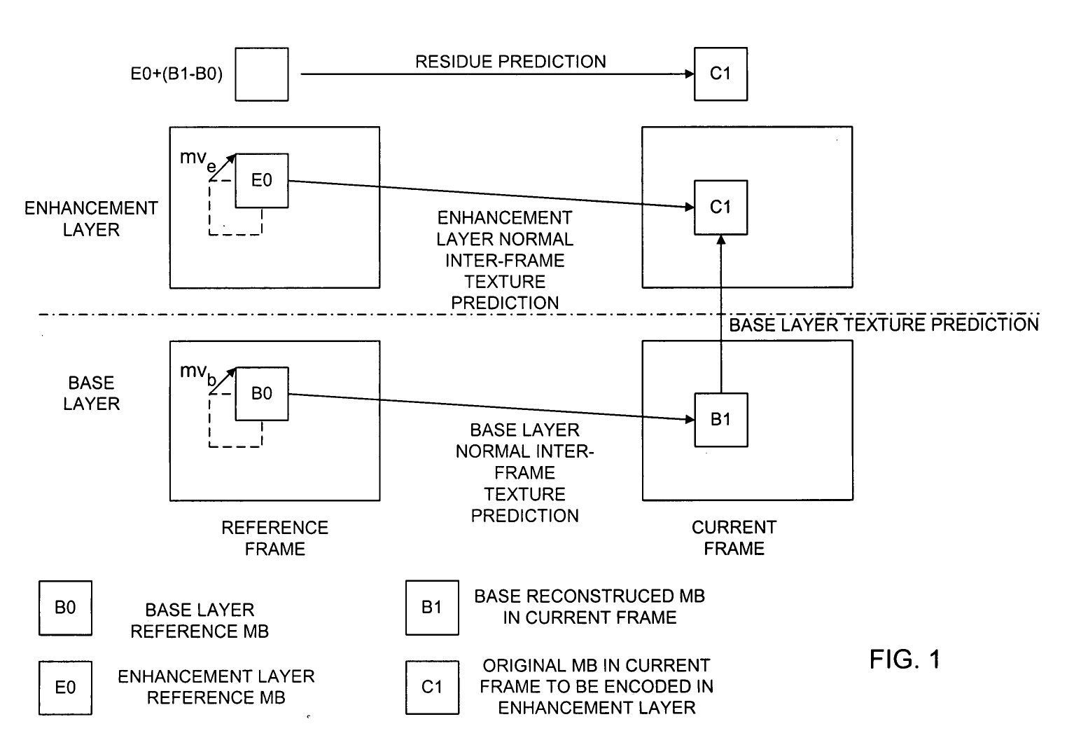

FIG. 2a shows the scanning of coefficients in a 4×4 base layer block and the resulting significant coefficient map in an H.264 codec.

FIG. 2b shows the scanning of coefficients in a 4×4 enhancement layer block and the resulting significant coefficient map, according to the present invention.

FIG. 2c shows the scanning of coefficients in a 433 4 extended enhancement layer block and the resulting significant coefficient map in multiple layer coding, according to the present invention.

FIG. 3 is a flowchart illustrating the method of coding the enhancement layer coefficients, according to the present invention.

FIG. 4 is a block diagram illustrating a communications device in which embodiments of the present invention can be implemented.

FIG. 5 is a block diagram illustrating a video encoder in which embodiments of the present invention can be implemented.

FIG. 6 is a block diagram illustrating a layered SVC in which embodiments of the present invention can be implemented.

### DETAILED DESCRIPTION OF THE INVENTION

In the discussion below, a base layer may be the absolute base layer, possibly generated by a non-scalable codec such as H.264, or it may be a previously-encoded enhancement layer that is used as the basis in encoding the current enhancement layer. The term “coefficient” below refers to a quantized coefficient value.

General Encoding Hierarchy in H.264

H.264 encodes the quantized coefficients in the hierarchy described blow.
1. An image or a video frame is partitioned into macroblocks (MB). An MB consists of 16×16 luminance block, 8×8 chrominance-Cb block, and 8×8 chrominance-Cr block. An MB skipping flag is sent in this level if all the information of this macroblock can be inferred from the information that is already encoded, by using pre-defined rules.
2. If the macroblock is not skipped, Coded Block Pattern (CBP) is sent to indicate the distribution of the nonzero coefficients in the macroblock.
3. After CBP is encoded, a coded block flag is sent in the next level for either 4×4 blocks or 2×2 blocks, depending on the coefficient type, to indicate whether there is any nonzero coefficient in the block.
4. If there are any nonzero coefficients in the block of size 4×4, or of size 2×2 for chroma DC coefficients, the coefficients are scanned in the predefined scanning order. The positions as well as the values of nonzero coefficients are encoded.

The present invention is mainly concerned with the coding of coefficients, as described in Step 4 above.

In H.264, a quantized coefficient can only be zero or nonzero. According to the present invention, coefficients can be further classified based on the value of the coefficients in the base layer. There are three cases regarding a coefficient's value in the enhancement layer:
1. The coefficient is zero both in the base layer and in the enhancement layer.
2. The coefficient is zero in the base layer, but nonzero in the enhancement layer. This coefficient is referred to as the new significant coefficient. The significance map coding determines the position of the all these coefficients. The sign needs to be sent additionally.
3. The coefficient is nonzero in the base layer, and more information in the enhancement layer is sent in order to make the coefficient more accurate. The additionally sent information in the enhancement layer for this coefficient is referred to as the refinement information. The refinement information of a coefficient may contain a sign bit.
   Generation of Base Layer Coefficients

If the base layer has the same resolution as that of the enhancement layer, the base layer coefficients can be directly used. If the base layer has a different resolution, the reconstructed prediction residues of the base layer are spatially filtered and re-sampled to match the resolution of the frame in the enhancement layer. The forward transform is performed on the re-sampled base layer reconstructed prediction residue and the transform coefficients are quantized. The quantized coefficients are used as the base layer coefficients in this coefficient coding scheme.

Coding of Significant Coefficient Map and Magnitude of New Significant Coefficients

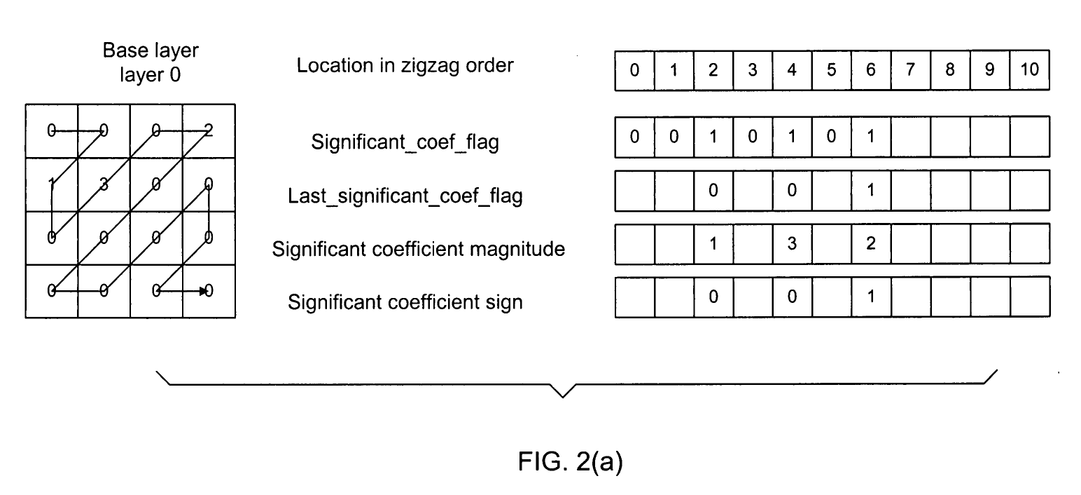

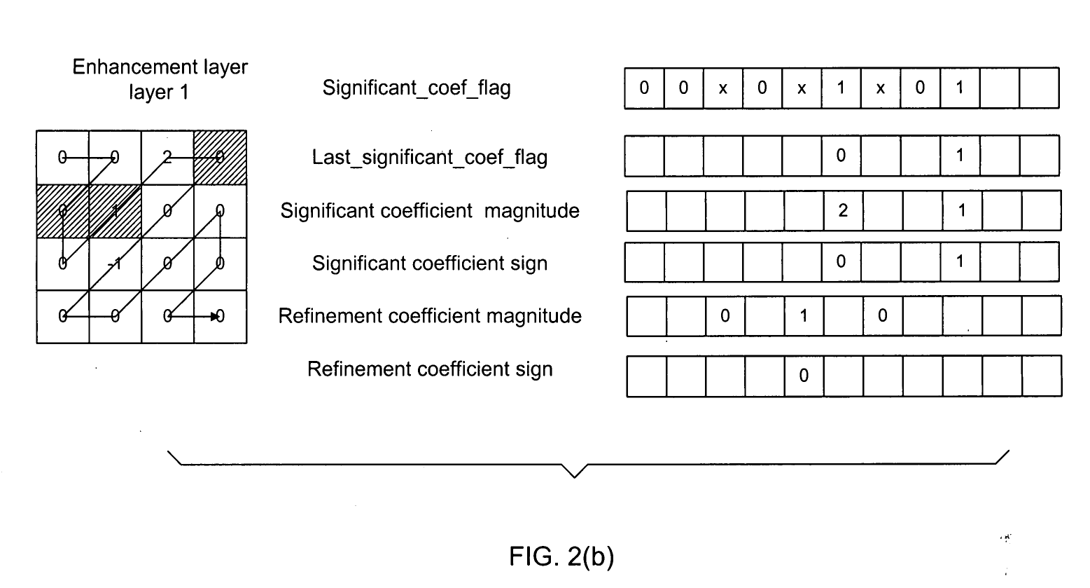

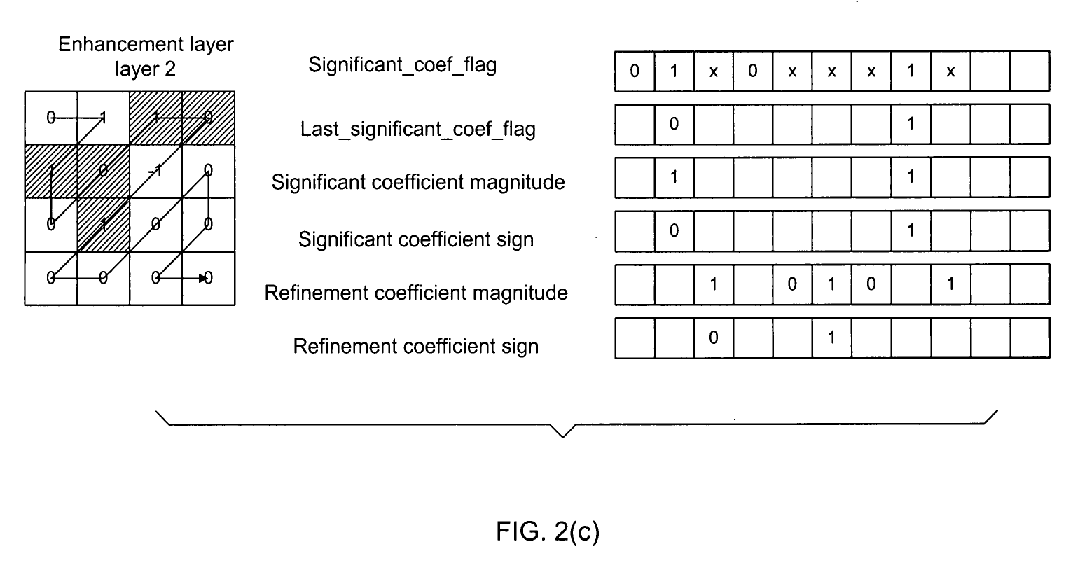

In H.264 which is a single-layer codec, locations of nonzero coefficients are coded using two flags: the significant_coeff_flag and the last_significant_coeff_flag. These flags are coded in the scanning order as defined in H.264. A significant_coeff_flag of value 1 is coded to indicate a nonzero coefficient at the current scanning position. A significant_coeff_flag of value 0 is coded to indicate a zero coefficient at the current scanning position. The last_significant_coeff_flag is coded after significant_coeff_flag if significant_coeff_flag is 1, i.e., the current coefficient is non-zero. The value of the last_significant_coeff_flag is 0, if there are more nonzero coefficients following the current nonzero coefficient in the scanning order. Otherwise the last_significant_coeff_flag is 1. Additionally, the magnitude information and sign bit are coded for each non-zero coefficient. The scanning of coefficients in the base layer and the enhancement layer and the resulting coefficient map are shown in FIG. 2a.

According to the present invention, the coefficient coding scheme in H.264 is extended to multi-layer coding. The scanning of coefficients in the enhancement layers and the resulting coefficient map are shown in FIGS. 2b and 2c. In one embodiment of the present invention, the significant_coeff_flag in the enhancement layer is coded only for a coefficient at a location where the coefficients at the same location in the base layer are zero. Same coding contexts defined in H.264 could be used. In another embodiment of the present invention, a different set of coding contexts can be used based on one or more of the following parameters:
1. The coefficient block type (like luma AC, luma DC, chroma DC, chroma AC etc.);
2. Whether the block in the base layer has nonzero coefficients;
3. The number of locations that have nonzero coefficients in the base layers; (for example, the blocks are categorized based on the number of nonzero coefficients, then use different contexts for different categories)
4. How the locations that have nonzero coefficients in the base layers are distributed in the block. (for example, the blocks in which the locations that have nonzero coefficients appear only at the beginning of the zigzag order are differentiated from the blocks in which the locations that have nonzero coefficients appear at the end of the zigzag order. Another example is that the coding contexts for the coefficients that are at locations before (in zigzag order) the last location that has a significant coefficient in the base layers are different from the coding contexts for the coefficients that are at locations after (in zigzag order) the last location that has a significant coefficient in the base layers.)

In one embodiment of the present invention, the last_significant_coeff_flag in the enhancement layer is defined similarly as it is in the base layer. The last_significant_coeff flag is sent only when the significant_coeff_flag in the enhancement layer is coded and the value of significant_coeff_flag is 1. Same coding contexts defined in H.264 could be used. In another embodiment, different set of coding contexts can be used based on the following parameters:
1. The coefficient block type (like luma AC, luma DC, chroma DC, chroma AC etc.);
2. Whether the block in the base layer has nonzero coefficients;
3. The number of locations that have nonzero coefficients in the base layers;
4. How the locations that have nonzero coefficients in the base layers are distributed in the block.

If the maximal absolute value of all coefficients is 1, no additional magnitude information needs to be coded. Otherwise the additional magnitude information is coded.

Coding of Refinement Coefficients

A refinement coefficient is generated in the enhancement layer for a location that there is at least one nonzero coefficient at the same location in the base layers. The refinement coefficient generally has one or multiple magnitude bits and one sign bit. With some particular quantization scheme, the refinement coefficient may not include a sign bit. According to the present invention, the refinement coefficient could be classified based on quantization results at all base layers, the prediction modes, and other parameters.

In one embodiment of the present invention, the refinement coefficients in the blocks that are predicted using BLTP (Base Layer Texture Prediction) are coded in different contexts from the refinement coefficients in the blocks that are not predicted using BLTP.

In another embodiment, the refinement coefficients in the blocks that have the same motion vectors as their corresponding blocks in the base layer are coded in different contexts from the refinement coefficients in the blocks that have different motion vectors from those of their corresponding blocks in the base layer.

According to the present invention, if a refinement coefficient has multiple magnitude bits, the magnitude bits can be coded in a single context or in multiple contexts. If the refinement coefficient has a sign bit, the sign bit of a coefficient could be coded in a context that is defined based on the sign bit of the corresponding coefficient in the base layer, if there is only one base layer.

If there are several SVC layers below the current layer, the refinement coefficients can be further classified based on the quantization results at all the layers starting from the layer where the first nonzero coefficient at the corresponding location appears. In one embodiment, the magnitude bits of refinement coefficients at locations which have non-zero coefficients only at the immediate base layer are coded in contexts different from the magnitude bits of other refinement coefficients. The coding contexts for the sign bits of the refinement coefficients at the current layer could depend on all or some of the sign bits of the coefficients at the same location, but in the base layers. The sign bits of those refinement coefficients at locations which have non-zero coefficients only at the immediate base layer are coded in contexts different from the sign bits of other refinement coefficients.

An exemplary video encoder that uses the inter-layer coefficient coding, according to the present invention, is described below:

An efficient coder could be designed using only 3 bits to record the quantization history information for entropy coding purpose, for each coefficient location. One bit is SIGN_BIT. The SIGN_BIT has the sign of the sign bit at the last layer where the coefficient at a particular location is non-zero. For example, SIGN_BIT is 0 before the coefficient at “location 2” at “layer 2” is coded, and this SIGN_BIT appears at layer 0. The second bit is SIGNIFICANCE_BIT. This bit indicates whether any coefficients at the same location are non-zero before the coefficient at the same location at the current layer is coded. In FIGS. 2b and 2c, SIGNIFICANT_BIT is 1 for the positions marked “x”. The third bit is the OLD_SIGNIFICANCE_BIT, and it is always 0 when SIGNIFICANCE_BIT is 0. This bit is also 0 when SIGNIFICANCE_BIT is 1 and before the current coefficient is coded, and the corresponding location has a non-zero coefficient only at the immediate base layer. When layer 1 is coded, there is no location has OLD_SIGNIFICANCE_BIT set to 1. When layer 2 is coded, “location 2” has OLD_SIGNIFICANCE_BIT set to 1, but “location 5” has OLD_SIGNIFICANCE_BIT set to 0. In this exemplary embodiment, 2 different sets of coding contexts are used for refinement information based on whether OLD_SIGNIFICANCE_BIT is 0 or 1.

Using Residue Prediction With New Entropy Coding

According to the present invention, the reconstructed prediction residue in the base layer can be modified before it is applied in residue prediction.

In one embodiment of the present invention, the residue is reduced in the absolute value in the spatial domain before it is used in predicting the enhancement layer prediction residue.

In another embodiment, the absolute value of transform coefficients of the prediction residues is reduced by a fixed value. If the absolute value of a coefficient is smaller than the fixed value, the coefficient is clipped to 0.

In yet another embodiment, the prediction residue in the base layer is not subtracted from the enhancement layer prediction residue. The base layer prediction residue can be transformed and quantized. These quantized coefficients can be used in classifying the coefficients that are being coded in the enhancement layer. The same classification strategies described above can be applied.

Adaptive Switch of Entropy Coding Schemes

The codec may dynamically switch between the new coefficient entropy coding scheme and the original AVC coefficient entropy coding scheme. A flag can be coded explicitly in either slice header to signal which entropy coding scheme is used for the slice. A flag can also be used in MB level to signal which entropy coding scheme is used for the MB. The MB-level switch can also be implicit depending on the relative quality of an MB in the enhancement layer with respect to that of the corresponding MB in the base layer. The quantization parameter of the MB in the enhancement layer and that of the corresponding MB in the base layer can be used for deriving the implicit flag value. The difference in quantization parameters in the enhancement layer and the base layer can be compared to a threshold to calculate the value of switch flag. In another embodiment, the flag value depends on the inter-layer prediction modes used by the MB so the new coefficient entropy coding scheme is used only for certain modes.

Initialization of New Coding Context

The initialization of the coding context is used for setting the symbols to be coded to some initial distribution. The performance can be improved if the initial distribution is a close approximation of the actual distribution. In a single layer codec, the coding contexts are normally initialized depending on the quantization parameter used. According to the present invention, the initialization of the coding contexts at the enhancement layer depends on quantization parameter at the enhancement layer as well as the difference between the quantization parameter at the enhancement layer and that at the base layer.

The present invention improves the enhancement layer coding performance by using the base layer information in coefficient entropy coding. It requires relatively minor changes to H.264. The entire CABAC core arithmetic coder is not modified at all. Many contexts defined in H.264 can still be used.

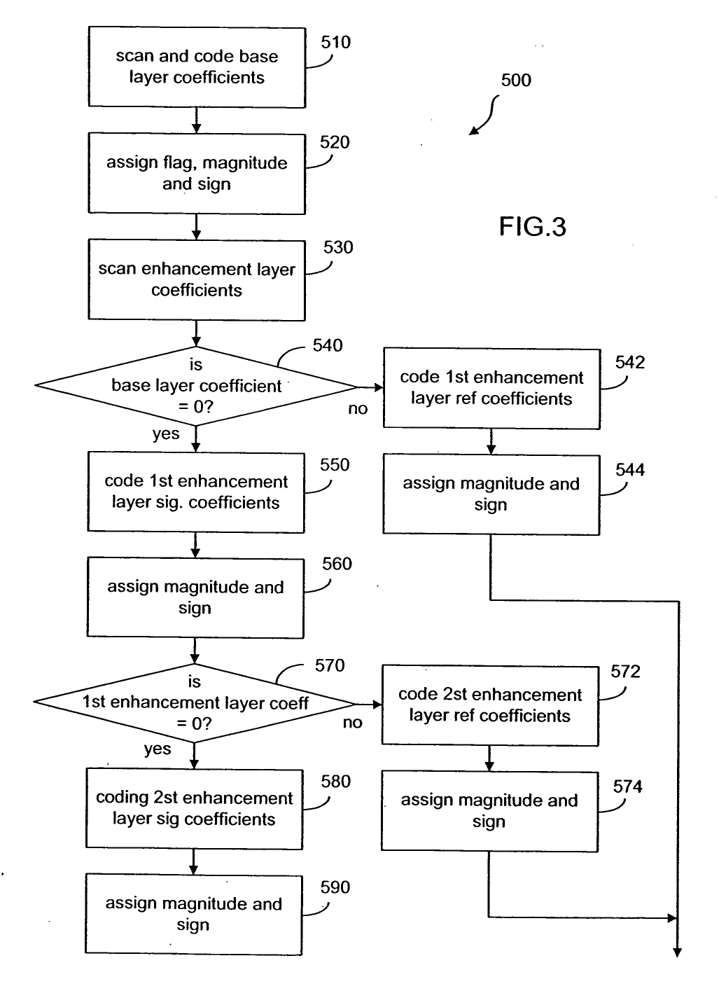

FIG. 3 is a flowchart illustrating the method of coding the enhancement layer coefficients, according to the present invention. As shown in the flowchart 500, the base layer coefficients and scanned and coded at step 510. At step 520, the flag, magnitude and sign of each base layer coefficients are assigned. At step 530, the coefficients in enhancement layers are scanned. At step 540, the coefficients of the first enhancement layer are coded according to the value of the co-located base layer coefficients. If the base layer coefficient is zero, the coefficient of the first enhancement layer is coded in the significant coefficient coding pass at step 550, and its magnitude and sign are assigned at step 560. Otherwise the coefficient is coded in the refinement pass at step 542 and its magnitude and sign are assigned at step 544. At step 570, the coefficients of the second enhancement layer are coded according to the value of the co-located first enhancement layer coefficients. If the first enhancement layer coefficient is zero, the coefficient of the second enhancement layer is coded in the significant coefficient coding pass at step 580, and its magnitude and sign are assigned at step 590. Otherwise the coefficient is coded in the refinement pass at step 572 and its magnitude and sign are assigned at step 574.

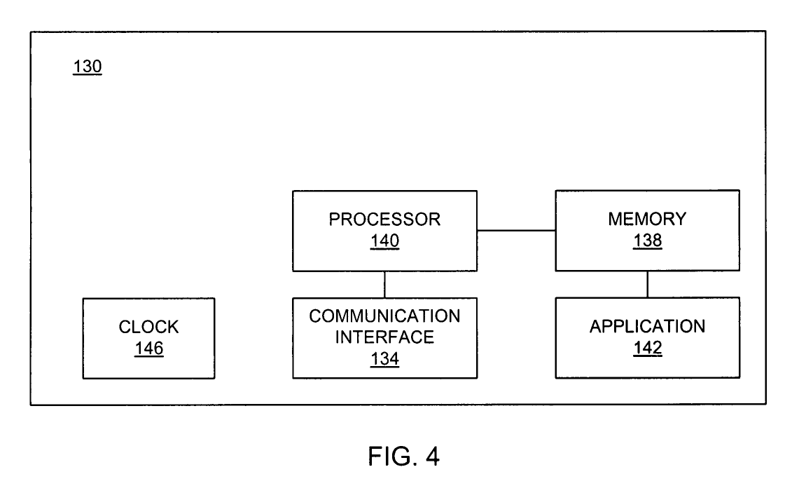

On possible implementation of the present invention is a part of a communications device or a communications network component (such as a mobile terminal, a base station, router, etc.). The communication device 130, as shown in FIG. 4, comprises a communication interface 134, a memory 138, a processor 140, an application 142, and a clock 146. The exact architecture of communication device 130 is not important. Different and additional components of communication device 130 may be incorporated into the communication device 130. For example, if the device 130 is a cellular telephone it may also include a display screen, and one or more input interfaces such as a keyboard, a touch screen and a camera. The scalable video encoding techniques of the present invention would be performed in the processor 140 and memory 138 of the communication device 130.

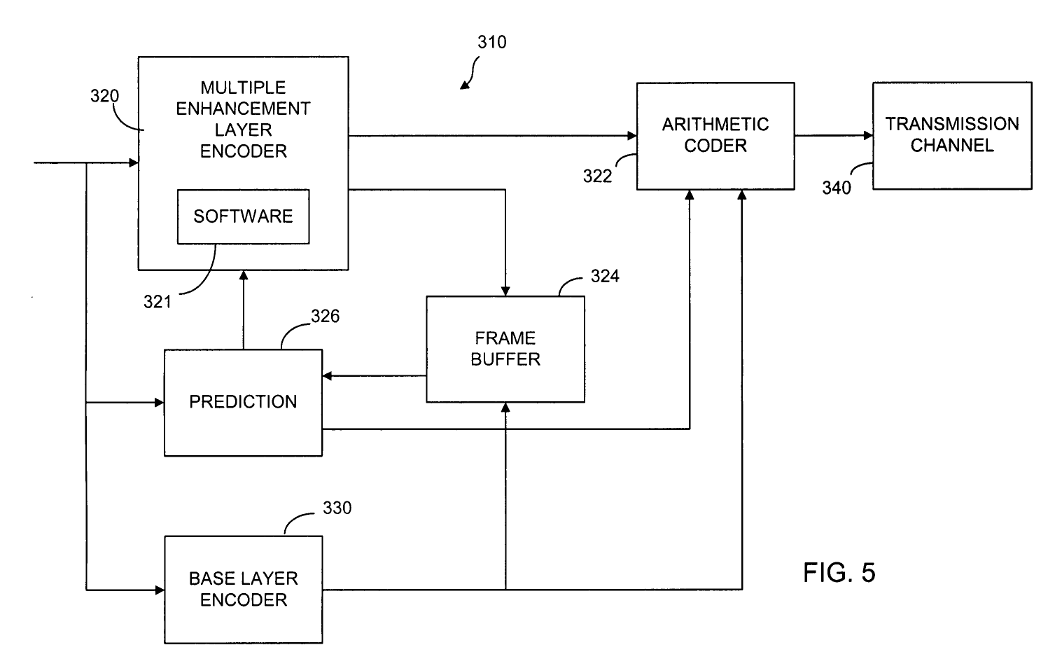

FIG. 5 illustrates a video encoder 310 that uses a refinement coefficient coding process to code the coefficients in the enhancement layers. As shown, the video encoder 310 comprises a multiple enhancement layer encoder 320 to code some of the coefficients in the enhancement layers in a refinement coding pass and the others in the significant coding pass and to convey the coded coefficients, their magnitude and sign to an arithmetic coding block 322. The enhancement layer encoding block 320 receives original signals indicative of the original value of the coefficients and provides reconstructed values of the coefficients to a frame buffer block 324. Based on signals indicative of coded information provided by the enhancement layer coding block 320 and motion information from the prediction block 326, the arithmetic coding block 322 submits encoded video data in a bitstream to a transmission channel 340. It is understood that the enhancement layer coding procedure can be carried out by hardware or software (software program 321) in the enhancement layer coding block 320. Furthermore, the video encoder 310 comprises a base layer encoder 330, operatively connected to the prediction block 326, the frame buffer block 324 and the arithmetic coding block 322, to carry out base layer encoding providing a signal indicative of base layer encoded data. The base layer encoder 330 as such is known in the art.

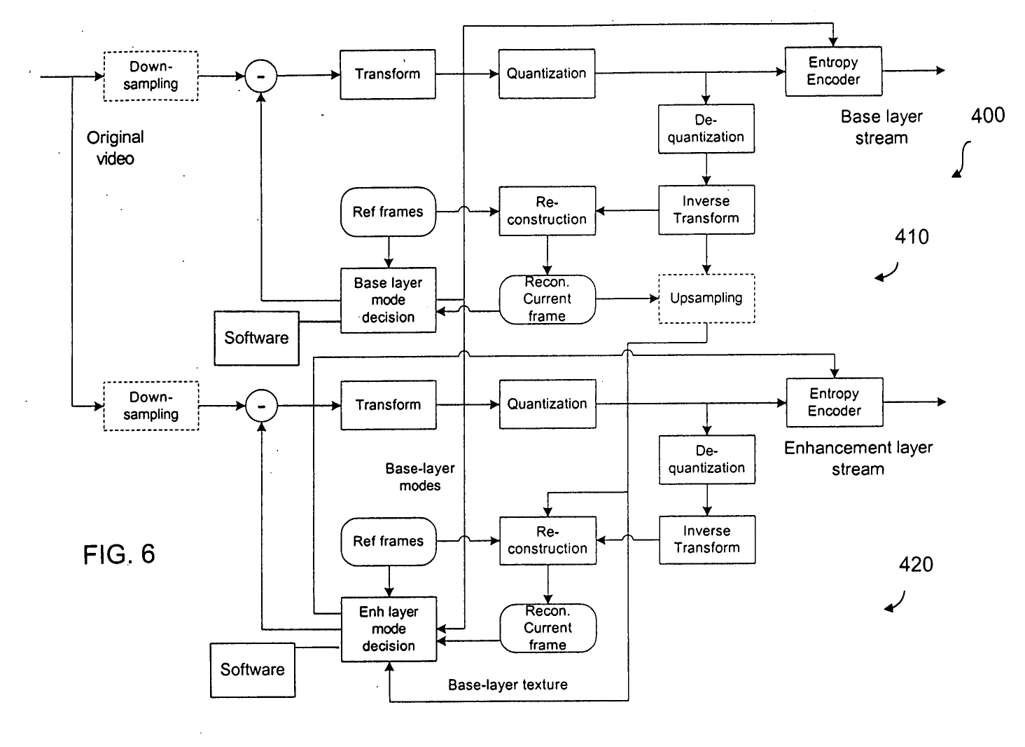

FIG. 6 shows a block diagram of a scalable video encoder 400 in which embodiments of the present invention can be implemented. As shown in FIG. 6, the encoder has two coding modules 410 and 420 each of the modules has an entropy encoder to produce a bitstream of a different layer. It is understood that the encoder 400 comprises a software program for determining how a coefficient is coded. For example, the software program comprises a pseudo code for scanning the enhancement layers and coding the coefficients in the enhancement layers in a significant pass or in a refinement draft based on conditions set forth in the embodiments described above.

Thus, although the invention has been described with respect to one or more embodiments thereof, it will be understood by those skilled in the art that the foregoing and various other changes, omissions and deviations in the form and detail thereof may be made without departing from the scope of this invention.

What is claimed is:

1. A method for use in scalable video coding for coding a video sequence having a plurality of frames, each frame partitioned into a plurality of blocks in a plurality of layers, said plurality of layers including a base layer and at least one enhancement layer, said enhancement layer having a plurality of coefficients, said base layer having a plurality of corresponding coefficients, each coefficient having a magnitude, said method comprising the steps of:
classifying coefficients from said enhancement layer as belonging to either a significance pass when the corresponding coefficient in said base layer is zero, or to a refinement pass when the corresponding coefficient in said base layer is non-zero;
for the coefficients classified as belonging to the significance pass, coding an indication of whether the coefficient is zero or non-zero, and if the coefficient is non-zero, coding an indication of the sign of the coefficient; and
for the coefficients classified as belonging to the refinement pass, coding a value to refine the magnitude of the corresponding coefficient in said base layer.

2. The method of claim 1, wherein a sign bit may be coded for the non-zero values in the refinement pass.

3. The method of claim 1, wherein the coefficients in said enhancement layer and the corresponding coefficients in said base layer are coded in a scanning order, and, for the coefficients classified as belonging to the significant pass, said indication comprises a significant coefficient flag.

4. The method of claim 3, wherein the scanning order is the scanning order of H.264, and the significant coefficient flag comprises a significant_coeff flag, and wherein contexts in H.264 entropy coding of the significant_coeff_flag are retained.

5. The method of claim 4, wherein a last_significant_coeff_flag is coded after the significant_coeff_flag and a value of the last_significant_coeff_flag indicates whether any more non-zero coefficients remain to be coded in the significant pass, and wherein contexts in H.264 entropy coding of the last_significant_coeff_flag are retained.

6. The method of claim 5, wherein when the value of the last significant_coeff_flag is equal to a predetermined value, the coding of remaining coefficients in the scanning order classified as belonging to the significance pass is skipped.

7. A scalable video encoder for coding a video sequence having a plurality of frames, each frame partitioned into a plurality of blocks in a plurality of layers, said plurality of layers including a base layer and at least one enhancement layer, said enhancement layer having a plurality of coefficients, said base layer having a plurality of corresponding coefficients, each coefficient having a magnitude, said encoder comprising:
a base layer encoder part, and
an enhancement encoder part, wherein the enhancement encoder part comprises:
means for scanning said enhancement layer in a predetermined scanning order for obtaining a string of coefficients, and means for coding the coefficients, and
wherein the base layer encoder part comprising:
means for scanning the base layer in the predetermined scanning order for obtaining a string of corresponding coefficients, and
means for coding the corresponding coefficients, wherein the coefficients from said enhancement layer are classified as belonging to either a significance pass when the coded corresponding coefficient in said base layer is zero, or to a refinement pass when the coded corresponding coefficient in said base layer is non-zero, and wherein the coding means in the enhancement encoder part further codes:
an indication of whether the coded coefficient is zero or non-zero for the coded coefficients classified as belonging to the significant pass, and an indication of a sign of the coefficient if the coefficient is non-zero; and
a value to refine the magnitude of the corresponding coefficient in the base layer for the coefficients as belonging to the refinement pass.

8. The encoder of claim 7, wherein a sign bit may be coded for the non-zero values in the refinement pass.

9. The encoder of claim 7, wherein the predetermined scanning order is the scanning order of H.264, and said coded indication comprises a significant_coeff_flag.

10. The encoder of claim 9, wherein the coding means in the enhancement encoder part further codes a last_significant_coeff_flag after the significant_coeff_flag and a value of the last_significant_coeff_flag indicating whether any more non-zero coefficients remain to be coded in the significant pass.

11. The encoder of claim 10, wherein when the value of the last significant_coeff_flag is equal to predetermined value, the coding of remaining coefficients in the scanning order classified as belonging to the significance pass is skipped.

12. A software application product comprising a storage medium having a software application for use in scalable video coding for coding a video sequence, the video sequence having a plurality of frames, each frame partitioned into a plurality of blocks in a plurality of layers, said plurality of layers including a base layer and at least one enhancement layer, said enhancement layer having a plurality of coefficients, said base layer having a plurality of corresponding coefficients, each coefficient having a magnitude, said application product comprising program codes for carrying out the method steps of claim 1.

13. A method for use in scalable video coding for decoding a video sequence having a plurality of frames, each frame partitioned into a plurality of blocks in a plurality of layers, said plurality of layers including a base layer and at least one enhancement layer, said enhancement layer having a plurality of coefficients, said base layer having a plurality of corresponding coefficients, each coefficient having a magnitude, said method comprising the steps of:
classifying coefficients from said enhancement layer as belonging to either a significance pass when the corresponding coefficient in said base layer is zero, or to a refinement pass when the corresponding coefficient in said base layer is non-zero;
for the coefficients classified as belonging to the significance pass, decoding an indication of whether the coefficient is zero or non-zero, and if the coefficient is non-zero, decoding an indication of the sign of the coefficient; and
for the coefficients classified as belonging to the refinement pass, decoding a value refining the magnitude of the corresponding coefficient in said base layer.

14. The method of claim 13, wherein a sign bit may be decoded for the non-zero values in the refinement pass.

15. The method of claim 13, wherein the coefficients in said enhancement layer and the corresponding coefficients in said base layer are decoded in a scanning order, and, for the coefficients classified as belonging to the significant pass, said indication comprises a significant coefficient flag.

16. The method of claim 15, wherein the scanning order is the scanning order of H.264, and the significant coefficient flag comprises a significant_coeff_flag, and wherein contexts in H.264 entropy decoding of the significant_coeff_flag are retained.

17. The method of claim 16, wherein a last_significant_coeff_flag is decoded after the significant_coeff_flag and a value of the last_significant_coeff_flag indicating whether any more non-zero coefficients remain to be decoded in the significant pass is coded, and wherein contexts in H.264 entropy decoding of the last_significant_coeff_flag are retained.

18. The method of claim 17, wherein when the coded value of the last significant_coeff_flag is equal to a predetermined value, the decoding of remaining coefficients in the scanning order classified as belonging to the significance pass is skipped, with those remaining coefficients assumed to have a magnitude of zero.

19. A scalable video decoder for decoding a video sequence having a plurality of frames, each frame partitioned into a plurality of blocks in a plurality of layers, said plurality of layers including a base layer and at least one enhancement layer, said enhancement layer having a plurality of coefficients, said base layer having a plurality of corresponding coefficients, each coefficient having a magnitude, wherein
the coefficients from said enhancement layer are classified as belonging to either a significance pass when the corresponding coefficient in said base layer is zero, or to a refinement pass when the corresponding coefficient in said base layer is non-zero, and
if the coefficients are classified as belonging to the significant pass, an indication is coded to indicate whether the coefficient is zero or non-zero, and if the coefficient is non-zero, a further indication is coded to indicate the sign of the coefficient, and
if the coefficients are classified as belonging to the refinement pass, a value is coded to refine the magnitude of the corresponding coefficient in the base layer, said decoder comprising:
a base layer decoder part having means for scanning said base layer in a predetermined scanning order for obtaining a string of the corresponding coefficients, and means for decoding the corresponding coefficients; and
an enhancement decoder part having means for scanning said enhancement layer in the predetermined scanning order for obtaining a string of the coefficients, and means for decoding the coefficients based on the indication, the further indication and the coded value to refine the magnitude of the corresponding in the base layer.

20. The decoder of claim 19, wherein a sign bit may be coded for the non-zero values in the refinement pass, and wherein the decoding means in the enhancement decoder part decodes the coefficients further based on the sign bit.

21. The decoder of claim 19, wherein the predetermined scanning order is the scanning order of H.264, and said coded indication comprises a significant_coeff_flag.

22. The decoder of claim 21, wherein a last_significant_coeff_flag is coded after the significant_coeff flag and a value of the last_significant_coeff_flag is coded to indicate whether any more non-zero coefficients remain to be coded in the significant pass, and wherein the decoding means in the enhancement decoder part decodes the coefficients further based on the last_significant_coeff_flag and the value of the last_significant_coeff_flag.

23. The decoder of claim 22, wherein when the value of the last significant_coeff flag is equal to predetermined value, the decoding of remaining coefficients in the predetermined scanning order classified as belonging to the significance pass is skipped, with those remaining coefficients assumed to have a magnitude of zero.

24. A software application product comprising a storage medium having a software application for use in scalable video coding for decoding a video sequence, the video sequence having a plurality of frames, each frame partitioned into a plurality of blocks in a plurality of layers, said plurality of layers including a base layer and at least one enhancement layer, said enhancement layer having a plurality of coefficients, said base layer having a plurality of corresponding coefficients, each coefficient having a magnitude, said application product comprising program codes for carrying out the method steps of claim 13.
